(19) United States
(12) Patent Application Publication
(10) Pub. No.: US 2016/0347559 A1
(43) Pub. Date: Dec. 1, 2016

(54) MOVEMENT AND MANAGING SYSTEM OF PALLETS TOWARDS/FROM A PANEL-CUTTING MACHINE

(71) Applicant: Giuseppe Gallucci, Monte Urano (FM) (IT)

(72) Inventor: Giuseppe Gallucci, Monte Urano (FM) (IT)

(21) Appl. No.: 14/725,324

(22) Filed: May 29, 2015

(51) Int. Cl. B65G 60/00; B65G 59/02; B65G 57/09

(52) U.S. Cl. CPC B65G 60/00; B65G 57/09; B65G 59/026

(57) ABSTRACT

A pallet transfer system for a panel-cutting machine has a working plane between a loading station and an unloading station. A first conveyor conveys a pallet with a stack of workpiece panels thereon from the inlet station to the loading station. A second conveyor conveys a pallet with a stack of cut panels thereon from the unloading station to an outlet station. A first support is actuable to move a pallet vertically upwards so as to enable transfer of a head panel of the stack of panels onto the working plane. A second support is actuable to position an empty pallet in the unloading station for movement vertically upwards to enable transfer of a cut panel onto the working plane on the pallet, so as to form a stack of panels on the pallet. A third conveyor is predisposed to convey an empty pallet from the loading station to the unloading station.

### DESCRIPTION OF THE INVENTION

Field of the Invention

The present invention relates to the technical sector of machine for cutting panels.

Description of the Prior Art

In particular, the invention relates to a system for movement (and managing) system of pallets towards/from a panel-cutting machine.

A machine for cutting panels comprises an operating unit provided with one or more cutting heads.

The machine acts on a working plane which is at a certain height from the ground and which restingly receives the panel to be cut.

The panels to be cut, which have considerable dimensions, are accumulated in a storehouse, and from there are positioned stacked on one another on a pallet.

A system for moving pallets of known type includes a first conveyor upstream of the working plane which conveys the pallets (and the stack of panels arranged thereon) from a feeding station towards a loading station of the panels to be cut, arranged in proximity of the working plane.

A second conveyor is further comprised downstream of the working plane, which extends from an unloading station of the cut panels to an outlet station.

First support means are included in the loading station, for lifting the pallets so that the head panel of the stack of panels can be transferred onto the working plane to be cut. In detail, the pallet is raised gradually as the stack of panels diminishes, until all the panels of the stack have been transferred onto the working plane.

Then the empty pallet is lowered and brought to the warehouse so as to receive another stack of panels to be cut.

Gradually, as the panels are cut, they are transferred from the working plane onto an empty pallet positioned in the unloading station. Second support means are provided here, so that the pallet can be raised and then gradually lowered so as to receives the cut panels up to forming a second stack.

The pallet is then brought by the second conveyor towards an outlet station, where the single panels are collected from the stack and the cut parts are separated from the waste parts.

The prior art system described above however has some drawbacks.

In fact, the empty pallets in the loading station are sent to the warehouse so as to receive another stack of panels to be cut, or are moved into the unloading station so as to receive a stack of cut panels. In this last case suitable gripping and movement means are included (such as, for example, handlers).

Therefore, the management of the pallets is particularly complicated and poorly practical, and where requested the use of handlers is also expensive.

### SUMMARY OF THE INVENTION

An aim of the present invention is to obviated the above-mentioned drawback. The above aim is attained with a movement and managing system of pallets towards/from a panel-cutting machine.

The disclosed system advantageously enables a managing and moving system of the pallets that is practical and functional, differently to the prior art.

Further, its use involves modest costs with respect to the known systems.

### BRIEF DESCRIPTION OF THE DRAWINGS

Specific embodiments of the invention and further advantages thereof will emerge more fully from the following description, with the aid of the figures of the drawings, in which:

FIGS. 1, 2 and 3 illustrate three lateral views of a system according to the invention, in three different operating situations;

FIG. 4 is a schematic view, in plan view, of a system according to the invention.

### DESCRIPTION OF PREFERRED EMBODIMENTS

With reference to the accompanying figures of the drawings, reference numeral (1) denotes a movement and managing system (1) of pallets (P) towards/from a panel-cutting machine (M). The machine (M) is, for example, of the type described in documents EP 2.488.333 and EP 2.601.121, filed in the name of the present Applicant.

The system (1) comprises a working plane (2) on which the panel-cutting machine (M) acts. The working plane (2) extends longitudinally between a loading station (C) of panels (F) to be cut and an unloading station (S) of cut panels (F); the work plane is further at a predetermined height from the ground and is predisposed to restingly receive a panel (F) to be cut.

The system (1) further comprises first conveyor means (3) which develop from an inlet station (I) to the loading station (C) of the panels (F) to be cut. The first conveyor means are predisposed to convey a pallet (P) on which a stack of panels (F) to be cut is positioned from the inlet station (I) to the loading station (C); in particular, the first conveyor means (3) are arranged at a lower height from the ground than the working plane (2).

Further, the system (1) further comprises second conveyor means (4) which develop from the loading station (C) to an outlet station (U). The second conveyor means (4) are predisposed to convey a pallet (P) on which a stack of panels (F) to be cut is positioned from the unloading station (S) to the outlet station (U) and are arranged at a lower height from the ground than the working plane (2).

The system (1) comprises first support means (5), arranged at the loading station (C) and actuable such that a pallet (P) on which a stack of panels (F) to be cut is positioned can be vertically moved upwards, in a stepped fashion, between a first position (Q1) and a second position (not visible in the figures), so as to enable, time-by-time, transfer (using means of known type) of a head panel of the stack of panels (F) (i.e. the panel on top of the stack) on the working plane (2). The first support means (5) are actuable such that the empty pallet (F) in the second position can be moved vertically downwards into the first position (Q1).

The system (1) further comprises second support means (6), arranged in the unloading station (S) and actuable such that an empty pallet (P) positioned in the unloading station (S) can be moved vertically upwards from a first position (not visible in the figures) to a second position (Q2); and are actuable such that the pallet (P) can be moved vertically, in a stepped fashion, downwards between the second position (Q2) and the first position, so as to enable, time-by-time (using known means), transfer of a cut panel (F) onto the working plane (2) on the pallet (P), so as to form a stack of panels (F). Clearly, when a pallet (P) is in the second position thereof in the loading station (C) or in the unloading station (S) it is substantially coplanar to the working plane (2).

In particular, the system (1) comprises third conveyor means (7) which develop at a lower height than the working plane (2), from the loading station (C) to the unloading station (S), and are predisposed to convey an empty pallet (P) from the loading station (C) to the unloading station (S).

The system (1) of the invention advantageously enables particularly practical moving and managing of the pallets towards and from a machine (M) for cutting the panels (F).

In fact, with the system (1) of the invention an empty pallet (P) which is in the loading station (C), following transfer of the panels (F) to be cut previously arranged thereon on the working plane (2), can be directly conveyed to the unloading station (S) where it can receive the cut panels.

In this way all the operations necessary for removing the empty pallets (P) in the loading station (C) which were necessary in the prior art are eliminated, as well as the operations for predisposing empty pallets in the unloading station (S).

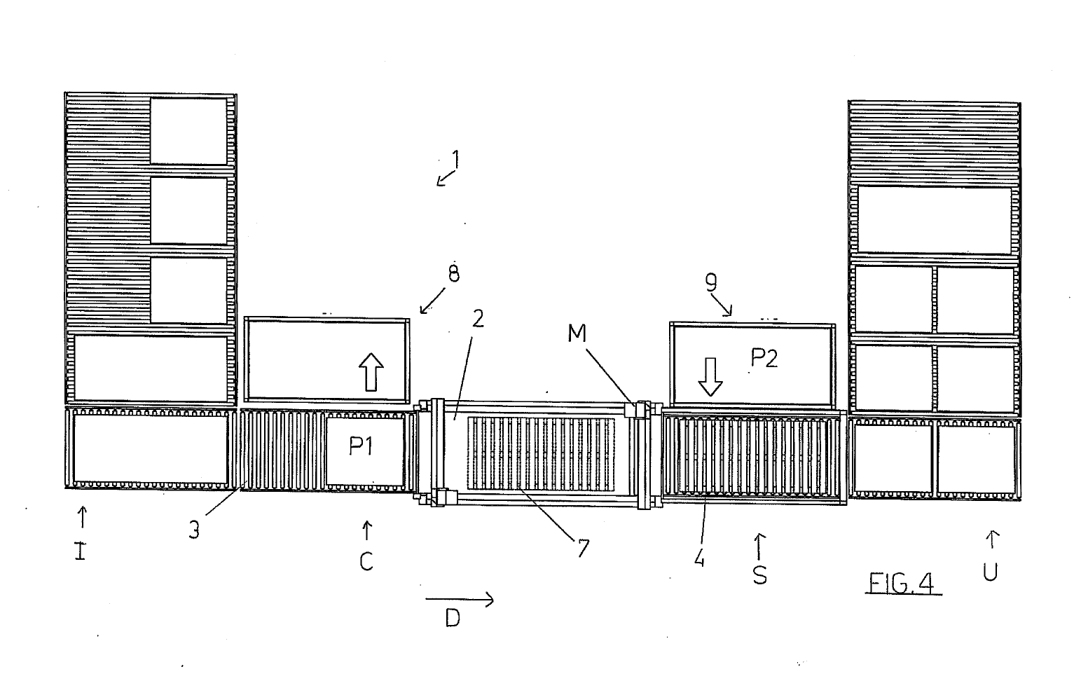

In the first illustrated embodiment, the first conveyor means (3), the second conveyor means (4) and the third conveyor means (7) develop along a longitudinal direction (D) parallel to the longitudinal development of the working plane (2). Naturally, the first conveyor means (3), the second conveyor means (4) and the third conveyor means (7) can also develop along different directions, for example in directions perpendicular to the above-mentioned longitudinal direction (D) (see for example FIG. 4).

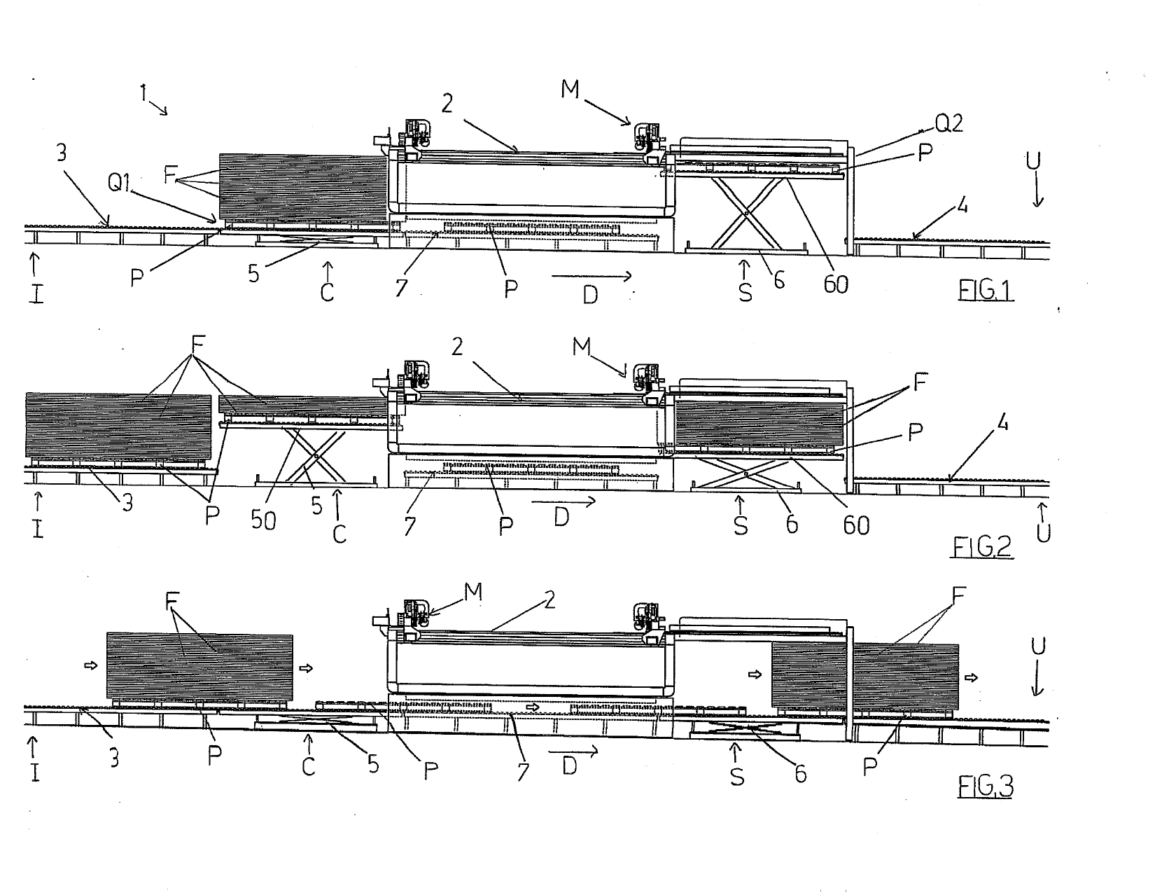

In greater detail, in the accompanying figures the third conveyor means (7) are arranged below the working plane (2) (visible in a broken line for example in FIGS. 1-3). Therefore, with this specification, the system (1) of the invention is particularly compact.

In the illustrated embodiment, the first conveyor means (3), the second conveyor means (4) and the third conveyor means (7) are arranged at a same height.

Still with reference to the accompanying figures, the first conveyor means (3), the second conveyor means (4) and the third conveyor means (7) comprise a roller conveyor.

In the illustrated embodiment, the first support means (5) and the second support means (6) each comprise a bench (50, 60) in turn comprising a roller conveyor.

With particular reference to FIG. 4, the system further comprises: a first warehousing station (8) arranged by a flank of the loading station (C); first transfer means (not illustrated) for transferring a first empty pallet (P1) having a determined size from the loading station (C) to the first warehousing station (8). This variant further includes a second warehousing station (9) arranged by a flank of the unloading station (S) and containing at least a second empty pallet (P2) having a determined dimension, greater than the dimension of the first pallet (P1), and second transfer means (not illustrated), for transferring the second pallet (P2) from the second warehousing station (9) to the unloading station (S). Detecting means are provided (not illustrated) for detecting a dimension of the first pallet (P1) arranged at the loading station (C).

To better understand the advantage of this particular embodiment, note that usually the panels (F) are of a standard type, and can be of a first dimension or a second dimension, which is double with respect to the first dimension.

The pallets (P) which go from the inlet station (I) and reach the unloading station C) are also dimensioned as a consequence of the above, i.e. there are first pallets (P1) present of a first dimension and second pallets (P2) of a second dimension, which is usually double the first dimension.

This particular embodiment is advantageous in various cases, for example in a case in which a first pallet (P1) reaches the loading station (C) and then a second pallet (P2) must be conveyed after the first pallet (P1) towards the loading station (C). In this case, therefore, the above-described variant is such that the panels (F) of the second pallet (P2) which reaches the loading station (C) (which could not be received for dimensional reasons from the first pallet (P1)) can be received in the unloading station (S), where another second pallet (P2) is taken which before was located in the second warehousing station (9).

The above-described is understood to have been described by way of non-limiting example, and any constructional variants thereof are understood to fall within the scope of the invention.

1. A movement and managing system of pallets alternately towards and from a panel-cutting machine, comprising:
a working plane on which the panel-cutting machine acts, and which: develops in a longitudinal direction between a loading station and an unloading station; is predisposed to restingly receive a panel to be cut;
first conveyor means which: develop from an inlet station to the loading station; are predisposed to convey a pallet on which a stack of panels to be cut is positioned from the inlet station to the loading station; are arranged at a lower height than the working plane;
second conveyor means which: develop from the unloading station to an outlet station; are predisposed to convey a pallet on which a stack of cut panels is positioned from the unloading station to the outlet station; are arranged at a lower height than the working plane;
first support means, arranged at the loading station and actuable such that a pallet on which a stack of panels to be cut is positioned can be vertically moved upwards, in a stepped fashion, between a first position and a second position, so as to enable, time-by-time, transfer of a head panel of the stack of panels on the working plane; and are actuable such that the pallet when empty in the second position can be moved vertically downwards into the first position;
second support means, arranged in the unloading station and actuable such that an empty pallet positioned in the unloading station can be moved vertically upwards from a first position to a second position; and are actuable such that the pallet can be moved vertically, in a stepped fashion, downwards between the second position and the first position, so as to enable, time-by-time, transfer of a cut panel onto the working plane on the pallet, so as to form a stack of panels on the pallet;
comprising:
third conveyor means which develop at a lower height than the working plane, from the loading station to the unloading station, and are predisposed to convey an empty pallet from the loading station to the unloading station.

2. The system of claim 1, wherein the third conveyor means are arranged below the working plane.

3. The system of claim 1, wherein the first conveyor means, the second conveyor means and the third conveyor means are arranged at a same height.

4. The system of claim 1, wherein the first conveyor means, the second conveyor means and the third conveyor means comprise a roller conveyor.

5. The system of claim 1, further comprising: a first warehousing station arranged by a flank of the loading station; first transfer means for transferring a first empty pallet having a determined size from the loading station to the first warehousing station; and a second warehousing station arranged by a flank of the unloading station and containing at least a second empty pallet having a determined dimension, greater than the dimension of the first pallet; second transfer means, for transferring the second pallet from the second warehousing station to the unloading station; detecting means, for detecting a size of the first pallet arranged in the loading station.

6. The system of claim 1, wherein the first conveyor means, the second conveyor means and the third conveyor means develop along a longitudinal direction parallel to the longitudinal development of the working plane.

7. The system of claim 1, wherein the first support means and the second support means each comprise a bench in turn comprising a roller conveyor.
